(19) United States
(12) Patent Application Publication
(10) Pub. No.: US 2022/0120565 A1
(43) Pub. Date: Apr. 21, 2022

(54) METHOD FOR DETERMINING A PHASE POSITION OF A ROTATION RATE SIGNAL OR A QUADRATURE SIGNAL, METHOD FOR ADAPTING A DEMODULATION PHASE, AND ROTATION RATE SENSOR

(71) Applicant: Robert Bosch GmbH, Stuttgart (DE)

(72) Inventors: Alexander Buhmann, Reutlingen (DE); Chinwuba Ezekwe, Albany, CA (US)

(21) Appl. No.: 17/450,939

(22) Filed: Oct. 14, 2021

(30) Foreign Application Priority Data
Oct. 21, 2020 (DE) 102020213286.0

(51) Int. Cl. G01C 19/5776

(52) U.S. Cl. CPC G01C 19/5776

(57) ABSTRACT

A method for determining a phase position of a rotation rate or quadrature signal of a rotation rate sensor. The rotation rate sensor include an oscillatory system which is excited to a drive oscillation and by rotations of the sensor to a detection oscillation. In a first step, a detection signal is ascertained over a time interval, the detection signal reflecting an amplitude of the detection oscillation as a function of time, in a second step, the detection signal is separated into a first and a second signal component, the first and the second signal component being statistically independent of one another, and in a third step, the phase position of the rotation rate signal or the quadrature signal is ascertained as a function of the first signal component and/or the second signal component. A method for adapting a demodulation phase and a rotation rate sensor are also provided.

### CROSS REFERENCE

The present application claims the benefit under 35 U.S.C. § 119 of German Patent Application No. DE 102020213286.0 filed on Oct. 21, 2020, which is expressly incorporated herein by reference in its entirety.

### FIELD

The present invention is directed to a method for determining a phase position of a rotation rate signal or a quadrature signal of a rotation rate sensor, the rotation rate sensor including an oscillatory system which, in sensor operation, is excited to a drive oscillation and is excited by rotations of the sensor to a detection oscillation.

### BACKGROUND INFORMATION

The basic physical principle of a rotation rate sensor is based on the fact that in the event of an external rotation, Coriolis forces act on the moving mass, the absolute value of these forces being proportional to the velocity of the mass and to the applied rotation rate. To make this effect of the rotation accessible to a measurement, the sensor typically has an elastically mounted mass which is excited to an oscillation in a drive direction and experiences an additional deflection in a detection direction due to the Coriolis force acting perpendicularly to the moving direction. At the same time, however, in general there is an undesirable mechanical coupling between drive direction and moving direction, which also results in deflections in the detection direction which are completely independent of the Coriolis force, however, and are referred to as the quadrature error. Such mechanical couplings may occur, for example, due to manufacturing-related deviations in the geometric shape of the mass or the elastic suspension and may result in corruption of the measured signal, due to which the accuracy of the sensor is reduced.

To separate these two components of the detection oscillation, the fact may be utilized that the useful component induced by the rotation is determined by the velocity of the mass, while the undesirable quadrature component is determined by the deflection of the mass and is therefore phase shifted in relation to the useful signal. Therefore, the useful signal may be separated from the quadrature component by demodulation on the basis of this phase shift. However, the technical problem results here that a change of the demodulation phase in open-loop systems results in rotation rate offsets (zero-rate offset, ZRO), which may be in the range of >0.5°/s (degrees per second, dps). This change has a variety of causes, for example, the temperature dependence of the phase of the detection oscillation or the influence of higher oscillation modes.

In conventional systems, attempts are either made to stabilize the phase curve by using a higher quality of the detection oscillation or calibration tables for the sensor element are stored in the ASIC (application-specific integrated circuit), which describe, for example, the dependence of the phase change on the temperature. However, only a blanket correction over large production batches may be implemented in this way, in which part-specific effects and deviations may not be taken into consideration.

### SUMMARY

It is an object of the present invention to provide a method by which the phase position of the rotation rate signal or quadrature signal may be determined during the sensor operation, so that in particular corresponding tracking of the demodulation phase may be carried out.

In accordance with an example embodiment of the present invention, the method may have the advantage over the related art that the rotation rate signal or quadrature signal may be identified on the basis of a statistical analysis of the detection signal and in this way a determination of the particular phase position or an adaptation of the demodulation phase is enabled.

The main feature of the present invention is that the rotation rate signal and the quadrature signal represent statistically independent variables which may be separated using a suitably implemented mathematical method. In this way, in particular a part-specific correction of the demodulation phase is enabled over the lifetime of the sensor and thus a significant reduction of the ZRO in open-loop systems is achieved. For the separation of the signal into rotation rate component and quadrature component, the fact is utilized that in particular the rotation rate signal has a different statistical distribution over a longer time period than the quadrature signal. The cause of this is that the rotational movements of the sensor dominate the signal statistics in the rotation rate channel, which are typically characterized by slow and sporadically fast signal changes. In contrast, the quadrature channel is primarily subject to slow changes which are caused by changes of mechanical tensions or the temperature.

The sensor includes an oscillatory system which may be deflected in a drive direction and a detection direction, which is different from the drive direction and in particular extends perpendicularly to the drive direction. During the sensor operation, the oscillatory system is excited, for example, by an electrostatic drive to a drive oscillation extending in the drive direction. The Coriolis forces induced by external rotations cause deflections in the detection direction, so that kinetic energy migrates from the drive movement into the detection movement. In practice, however, in addition to this effect, a mechanical coupling exists between drive movement and detection movement, so that deflections in the drive direction induce mechanical forces in the detection direction and in this way cause detection deflections which are independent of the Coriolis forces (quadrature). The deflections in the detection direction are measured, for example, via a capacitance change between the moving mass and the substrate-fixed electrodes and converted into an electrical signal which reflects the amplitude as a function of the time. Both the actual rotation rate signal (caused by the Coriolis deflections) and the quadrature signal (caused by the quadrature effect) are incorporated in this detection signal.

Due to the above-described fact that rotation rate signal and quadrature signal are statistically independent of one another, a separation of the two components may be carried out, thus the detection signal may be separated into two signal components which at least approximately correspond to the rotation rate signal or the quadrature signal. Diverse methods are available in the related art for the separation into statistically independent signals. This separation is preferably based on a statistical model in which further assumptions about the statistics of the signal fluctuations may be incorporated in addition to the independence of the signal components. The detection signal is then represented by a mixture of the two signal components, the components each having an (unknown) phase. Two signal components and their phases, which correspond with maximum probability to implementations of the statistical model, may be identified from the requirement of statistical independence on the basis of the model.

The main feature of the present invention permits multiple advantageous specific embodiments which are described hereinafter.

According to one preferred specific embodiment of the method according to the present invention, the detection signal is a digital data signal and the separation of the detection signal is carried out by digital signal processing. The analog signal which describes the deflection of the moving mass as a function of time is converted in this specific embodiment, for example, by an analog-to-digital converter into a digital signal, so that advantageously various methods of digital signal processing are available for the further processing.

According to one preferred specific embodiment of the method according to the present invention, the detection signal is the sum of the first and second signal component. It is also possible that the detection signal is a linear combination of the first and second signal component, however, more general forms of signal mixing also being possible. The form of the signal mixture is preferably incorporated into a statistical model which underlies the separation of the detection signal.

Multiple mathematical methods are available for the separation of the detection signal, which are implemented in particular by a data processing method and are particularly preferably carried out by a data processing unit.

According to one preferred specific embodiment of the method according to the present invention, the separation of the detection signal is carried out by blind signal separation. According to another preferred specific embodiment of the method according to the present invention, the separation of the detection signal is carried out by independent component analysis. According to another preferred specific embodiment of the method according to the present invention, the separation of the detection signal is carried out by principal component analysis. According to another preferred specific embodiment of the method according to the present invention, the separation of the detection signal is carried out by an expectation-maximization algorithm. Further methods, for example, the separation by a neural network, are also possible. In this way, the two signal components may be reconstructed in a precise and efficient manner on the basis of the detection signal.

A further subject matter of the present invention is a method for adapting a demodulation phase of a rotation rate sensor. Building on the method as mentioned above, the phase position of the rotation rate signal or the quadrature signal is initially determined here and this information is used in a following step (e.g., FIG. 1, step 4) for the adaptation or correction of the demodulation phase.

A further subject matter of the present invention is a rotation rate sensor. The rotation rate sensor according to the present invention includes a data processing unit, in particular a digital data processing unit, which is configured to carry out a method according to an example embodiment of the present invention as disclosed herein. The advantages mentioned with reference to these methods are transferred directly to the rotation rate sensor according to the present invention.

### BRIEF DESCRIPTION OF THE DRAWINGS

FIG. 1 is a schematic representation of the method according to the present invention for determining a phase position of a rotation rate signal or a quadrature signal and the demodulation of the detection signal.

FIG. 2 illustrates the separation according to the present invention of the detection signal into a first and a second signal component.

### DETAILED DESCRIPTION OF EXAMPLE EMBODIMENTS

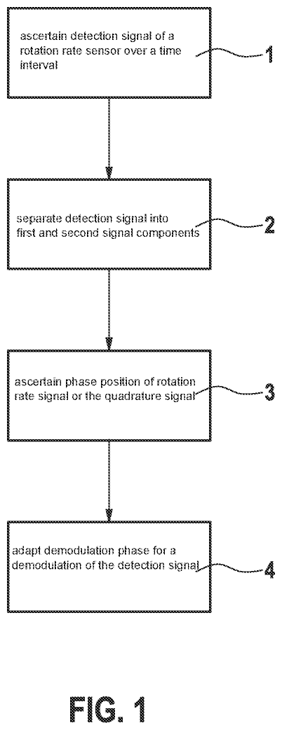

FIG. 1 is a schematic representation of the method according to the present invention. In a first step 1, a detection signal 10 of a rotation rate sensor is ascertained in the sensor operation over a time interval, detection signal 10 reflecting an amplitude of the detection oscillation as a function of time. During this time interval, the sensor is subject to external rotations which induce deflections in the detection direction due to the Coriolis forces linked thereto. In addition, undesirable deflections in the detection direction are induced by quadrature effects, so that both the actual rotation rate signal and a quadrature signal are incorporated into detection signal 10, the particular components or phases of which are reconstructed by the following steps from detection signal 10. In a second step 2 following first step 1, for this purpose a separation of detection signal 10 into a first and a second signal component 11, 12 takes place, first and second signal components 11, 12 being statistically independent of one another. To carry out the separation under the assumption of statistical independence, various methods are available, for example, blind signal separation, independent component analysis, principal component analysis, or an expectation-maximization algorithm. In a third step 3 following second step 2, the phase position of the rotation rate signal or the quadrature signal is then ascertained as a function of first signal component 11 and/or second signal component 12.

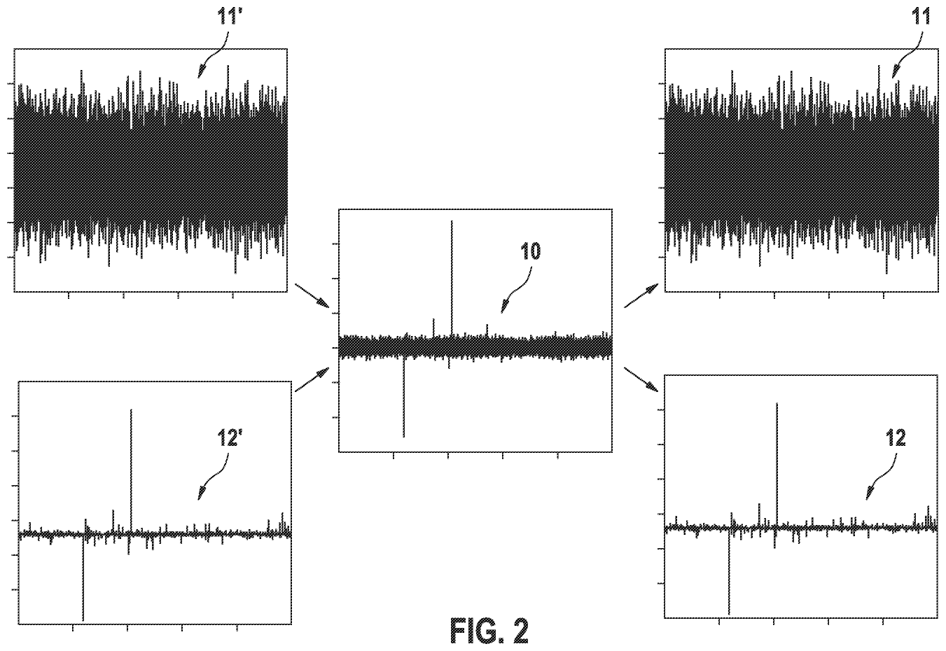

FIG. 2 illustrates the separation according to the present invention of detection signal 10 into a first and a second signal component 11, 12. In each case the amplitude is shown as a function of time. Two signals 11′, 12′ having different statistical behavior are depicted on the left side as examples, signal 11′ being able to be a quadrature signal and signal 12′ a rotation rate signal. The two signals 11′, 12′ were mixed to form a detection signal 10 by the unknown demodulation phase and subsequently measured by the ASIC. The signals may then be separated back into components 11 and 12, which at least approximately correspond to original signals 11′ and 12′, by statistical methods, for example, ICA (independent component analysis).

What is claimed is:

1. A method for determining a phase position of a rotation rate signal or a quadrature signal of a rotation rate sensor, the rotation rate sensor including an oscillatory system which, in sensor operation, is excited to a drive oscillation and is excited by rotations of the sensor to a detection oscillation, the method comprising the following steps:
in a first step in the sensor operation, ascertaining a detection signal over a time interval, the detection signal reflecting an amplitude of the detection oscillation as a function of time;
in a second step, carrying out a separation of the detection signal into a first signal component and a second signal component, the first signal component and the second signal component being statistically independent of one another; and
in a third step, ascertaining the phase position of the rotation rate signal or the quadrature signal as a function of the first signal component and/or the second signal component.

2. The method as recited in claim 1, wherein the detection signal is a digital data signal and the separation of the detection signal is carried out by digital signal processing.

3. The method as recited in claim 1, wherein the detection signal is a sum of the first signal component and the second signal component.

4. The method as recited in claim 1, wherein the separation of the detection signal is carried out by blind signal separation.

5. The method as recited in claim 1, wherein the separation of the detection signal is carried out by independent component analysis.

6. The method as recited in claim 1, wherein the separation of the detection signal is carried out by principal component analysis.

7. The method as recited in claim 1, wherein the separation of the detection signal is carried out by an expectation-maximization algorithm.

8. A method for adapting a demodulation phase of a rotation rate sensor, the rotation rate sensor including an oscillatory system which, in sensor operation, is excited to a drive oscillation and is excited by rotations of the sensor to a detection oscillation, the method comprising the following steps:
in a first step in the sensor operation, ascertaining a detection signal over a time interval, the detection signal reflecting an amplitude of the detection oscillation as a function of time;
in a second step, carrying out a separation of the detection signal into a first signal component and a second signal component, the first signal component and the second signal component being statistically independent of one another;
in a third step, ascertaining the phase position of the rotation rate signal or the quadrature signal as a function of the first signal component and/or the second signal component; and
in a fourth step, adapting the demodulation phase for a demodulation of the detection signal, the adaptation of the demodulation phase being carried out as a function of the phase position of the rotation rate signal or the quadrature signal.

9. A rotation rate sensor, comprising:
an oscillatory system; and
a data processing unit, the oscillatory system being excitable to a drive oscillation and to a detection oscillation extending perpendicularly to the drive oscillation, the data processing unit being configured to determine a phase position of a rotation rate signal or a quadrature signal of the rotation rate sensor, the data processing unit configured to:
ascertain, in the sensor operation, a detection signal over a time interval, the detection signal reflecting an amplitude of the detection oscillation as a function of time;
carry out a separation of the detection signal into a first signal component and a second signal component, the first signal component and the second signal component being statistically independent of one another; and
ascertain the phase position of the rotation rate signal or the quadrature signal as a function of the first signal component and/or the second signal component.
